(19) United States
(12) Patent Application Publication
(10) Pub. No.: US 2008/0169675 A1
(43) Pub. Date: Jul. 17, 2008

(54) Meter Bracket and Method of Attaching Same

(75) Inventor: Michael J. Hebert, Evans, GA (US)

Correspondence Address: HARNESS, DICKEY & PIERCE, P.L.C., P.O. BOX 828, BLOOMFIELD HILLS, MI, 48303, US

(73) Assignee: TEXTRON INC., Providence, RI (US)

(21) Appl. No.: 11/622,019

(22) Filed: Jan. 11, 2007

(51) Int. Cl. F16L 3/00

(52) U.S. Cl. 296/187.01; 248/218.4

(57) ABSTRACT

A bracket can be easily attached to and removed from a support structure of a small utility vehicle. The bracket can receive a gauge or meter therein. The bracket can include features that facilitate the attachment and removal of the bracket to the support structure. The bracket can be configured to utilize existing fasteners to retain the bracket to the support structure. The bracket can be configured to facilitate attachment to and removal from the support structure using these existing fasteners without detaching other components from the small utility vehicle that the existing fasteners secure to the support structure.

### FIELD

The present disclosure relates to a bracket, for example, in golf cars and small utility vehicles.

### BACKGROUND

The statements in this section merely provide background information related to the present disclosure and may not constitute prior art.

Small utility vehicles can include: golf cars, shuttle personnel carriers, refreshment vehicles, industrial utility vehicles and/or or trail utility vehicles. The small utility vehicles come in many different configurations that vary in both size and components or features that are present thereon.

The small utility vehicles can include various gauges or meters (hereinafter referred to simply as meters) to provide information about the operation of the small utility vehicle. The brackets are used to attach these meters to the desired location within the small utility vehicle. Typically, the brackets are welded to a support structure and the meter is bolted thereto. The welding of the bracket to a support structure is typically done during the assembly of the small utility vehicle. The bracket may be attached to a location on the support structure that will not interfere with the various components that may be included in the various configurations that the small utility vehicle can be configured in. This location, however, may not be an ideal location for any one of the particular configurations and, rather, may be a compromise between the various configurations. Thus, the location at which the bracket is positioned may be less than optimal for one or more configurations and the possible locations that are acceptable for all of the configurations may be limited. With the bracket being welded to the support structure, removal of the bracket can be difficult. Additionally, removal of the meter from the bracket can be hampered and/or difficult in that fasteners, such as nuts and bolts, must be physically removed from the bracket to remove the meter. The location of the bracket may also interfere with the maintenance and/or repair of the small utility vehicle. That is, with the bracket being fixed in place, the bracket may interfere with access to components of the small utility vehicle and to the use of tools.

Accordingly, it would be advantageous if the bracket could be easily installed and/or removed. Additionally, it would be advantageous if such installation or removal of the bracket were performed in a simple manner. Moreover, it would be advantageous if a bracket could be mounted in a variety of locations. Additionally, it would be advantageous if the bracket could be mounted using existing fasteners that are securing other components to the small utility vehicle.

### SUMMARY

A meter bracket for small utility vehicles is provided in the present disclosure. The bracket can be configured to be easily secured to and removed from a support structure of the small utility vehicle. The bracket can be mounted in various locations on the support structure. The bracket can be mounted without the use of additional fasteners by using fasteners that secure other components to the support structure.

A meter mounting bracket according to the present disclosure includes a single unitary body. The body can have a first elongated slot. The first slot can have a first open end opening in a first direction. The body can have a second elongated slot. The second slot can have a second open end opening in a second direction different than the first direction. The body can include a component retaining feature to enable a component to be attached thereto.

A small utility vehicle according to the present disclosure can include a frame and at least one driven wheel coupled to the frame. A drive unit can be coupled to the frame and to the at least one driven wheel. A structural member can also be coupled to the frame. The structural member can have a pair of openings therein. A single unitary bracket can be attached to the structural member. The bracket can have a first slot with a first open end opening in a first direction. The bracket can have a second slot having a second open end opening in a second direction different than the first direction. The first and second slots can each be aligned with different ones of the openings in the pair of openings in the structural member. A pair of fasteners can be disposed in the pair of openings and in the slots. The fasteners can secure the bracket to the structural member.

A method of securing a meter bracket to a small utility vehicle according to the present disclosure includes: (1) aligning a first open end of a first slot of a bracket with a first fastener extending through a structural member of the small utility vehicle, the first open end opening in a first direction; (2) engaging the first slot with the first fastener; (3) engaging a second open ended slot of the bracket with a second fastener extending through the structural member, the second slot having a second open end opening in a second direction different than the first direction; and (4) securing the bracket to the structural member with the first and second fasteners.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a small utility vehicle configured as a golf car, in accordance with the present disclosure;

FIG. 2 is a top plan view of a bracket according to the present disclosure;

FIG. 3 is a perspective view of the bracket of FIG. 2 with a meter disposed therein;

FIG. 4 is a fragmented perspective view of a portion of the area of the small utility vehicle of FIG. 1 beneath the front seating area showing a location where the bracket of the present teachings can be attached; and

FIGS. 5-7 are top plan views illustrating the attachment of the bracket of FIG. 2 to a support structure in accordance with the present disclosure.

### DETAILED DESCRIPTION

The following description is merely exemplary in nature and is in no way intended to limit the present disclosure, application, or uses. Throughout this specification, like reference numerals will be used to refer to like elements.

According to the various embodiments, a bracket can be easily attached to and removed from a support structure of a small utility vehicle. The bracket can receive a gauge or meter therein (hereinafter referred to simply as a meter). The bracket can include features that facilitate the attachment and removal of the bracket to the support structure. The bracket can be configured to utilize existing fasteners to retain the bracket to the support structure. The bracket can be configured to facilitate the attachment to and removal from the support structure using these existing fasteners without detaching other components from the small utility vehicle that the existing fasteners secure to the support structure.

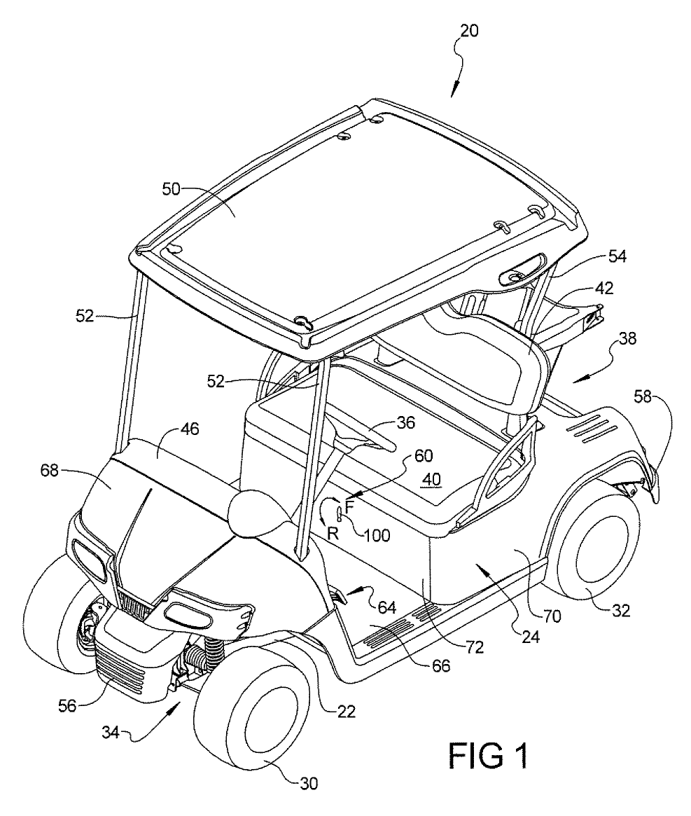

Referring to FIG. 1, an exemplary small utility vehicle 20, in this case in the form of a golf car, according to the present disclosure is shown. As used herein, the term “small utility vehicle” includes, but is not limited to, shuttle personnel carriers, refreshment vehicles, industrial utility vehicles, golf cars and/or trail utility vehicles. Vehicle 20 includes various components that are mounted to a frame 22. The components may vary based upon the configuration or type of small utility vehicle to be formed. Vehicle 20 can include various body panels 24. In some embodiments, the various body panels can be combined to form unitary body panels or serve multiple purposes or cover multiple areas of vehicle 20. Thus, it should be appreciated that the body panels shown are merely exemplary in nature. The various body panels can be directly or partially attached to frame 22 and/or supported by other brackets or structural members that are coupled to frame 22. Frame 22 can also support a plurality of wheels including steerable wheels 30 in addition to powered or driven wheels 32. A front suspension system 34 can be used to support steerable wheels 30. Driven wheels 32 are commonly connected to a rear structural portion of frame 22 with a rear suspension system (not shown). A steering mechanism 36, which commonly includes a steering wheel and a support post assembly, can also be included to provide the steering input to steerable wheels 30.

Vehicle 20 may also include a front seating area 38 including a bench seat 40 and a back support cushion 42. An instrument panel 46 can be included in a front portion of vehicle 20 and may house various components, such as instruments controlling the operation of vehicle 20 and/or indicating the operational status of vehicle 20 along with storage compartments and the like by way of non-limiting example.

A cover or roof 50 can be provided which can be supported from either frame 22 or a structural member coupled thereto such as by front and rear canopy struts 52, 54. A windscreen or windshield (not shown) can also be provided which can be supported by the front canopy strut 52, which can be U-shaped. Front and rear bumpers 56, 58 can be attached to frame 22. Other items that can be provided when vehicle 20 is in the form of a golf car include golf bag support equipment, accessory racks or bins, headlights, side rails, fenders or the like. Moreover, when vehicle 20 is configured as other types of vehicles, a rear-facing seat or multiple rows of seats may be included, a storage bed (tiltable or fixed) may be attached to the rear portion of vehicle 20, beverage compartments may be attached to the rear portion of vehicle 20 and the like, by way of non-limiting example.

Vehicle 20 is commonly propelled by a power unit (not shown), which is commonly disposed behind or below bench seat 40. The power unit can include an internal combustion engine assembly or a battery and electric motor assembly. The power unit drives driven wheels 32 and is typically coupled to a drive axle interconnecting driven wheels 32. The power unit enables driven wheels 32 to propel vehicle 20 in both a forward and rearward direction with steering input provided by steerable wheels 30 via input from steering mechanism 36. Vehicle 20 can include a direction lever assembly 60 that is operable to cause the power unit to drive driven wheels 32 in a desired direction of rotation, as described below. Vehicle 20 can also include a pedal assembly 64 that controls the output level of the power unit and the braking function of vehicle 20. Pedal assembly 64 can be attached to frame 22 and can extend through a floorboard 66 also attached to frame 22. Body 24 can include a front fascia 68 along with side panels 70 and a front seat panel 72 to hide the internal components of vehicle 20 from view and provide a desired aesthetic appearance. Body 24 can also protect the internal components of vehicle 20 from the weather and incidental contact.

Vehicle 20 can include numerous meters that are attached thereto and can provide information regarding the operation, current or historical of vehicle 20. By way of non-limiting example, vehicle 20 can include an hour meter that records the number of hours that vehicle 20 has been operated. The meter can be attached to vehicle 20 through use of a bracket.

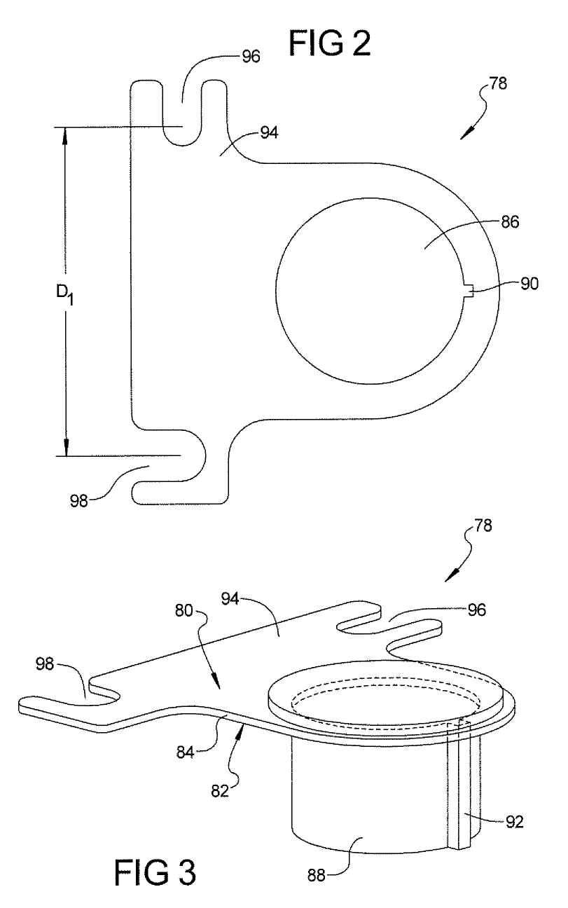

Referring now to FIGS. 2 and 3, an exemplary bracket 78 according to the present disclosure is shown. Bracket 78 can be configured to easily attach to vehicle 20 in a variety of locations. Bracket 78 can include opposite top and bottom surfaces 80, 82 and a side wall 84 extending therebetween and defining an outer periphery of bracket 78. Bracket 78 can include a meter retaining feature operable to secure a meter 88 to bracket 78. By way of non-limiting example, the retaining feature of bracket 78 can include a through opening 86 extending between top and bottom surfaces 80, 82. Opening 86 can be configured to receive meter 88. In the exemplary bracket 78 shown, bracket 78 includes a single opening 86 for receiving meter 88. It should be appreciated, however, that bracket 78 can have more than one opening 86 to hold more than one meter 88 or to provide a different way of attachment, as desired. Opening 86 can include an alignment feature 90 that is complementary to an alignment feature 92 on meter 88 to facilitate the alignment of meter 88 within bracket 78 in a desired orientation. By way of non-limiting example, alignment feature 90 can be a square keyway and alignment feature 92 can be a key having a square cross section. Meter 88 can be configured to be pressfit or snapfit into bracket 78. Pressfitting or snapfitting meter 88 into bracket 78 eliminates the need for loose fasteners to secure meter 88 in bracket 78.

Bracket 78 can be a single unitary member and can include a mounting portion 94 that can be configured to facilitate the attachment of bracket 78 to vehicle 20. Mounting portion 94 can include a first open ended channel or slot 96 oriented in a first direction and a second open ended channel or slot 98 oriented in a second direction. Channels 96, 98 can be co-planar. Channels 96, 98 can be U-shaped in plan view, as shown in FIG. 2. The first direction can be perpendicular to the second direction, as shown. That is, the opening of first channel 96 can be oriented to open in a direction that is perpendicular to the direction to which the opening of second channel 98 opens, as shown. Channels 96, 98 can facilitate the attachment of bracket 78 to vehicle 20 using fasteners that are already disposed on vehicle 20 and used for other purposes, as described below. The center of first channel 96 can be spaced apart from the center of second channel 98 a distance of D₁. Bracket 98 can be made from a variety of materials. For example, bracket 98 can be steel and can be formed by stamping. Bracket 98, if desired, can also be made from a polymeric material. Bracket 98 can be coated with a rust-inhibiting layer, such as paint, powder coating and/or electroplating.

Bracket 78 can be configured to attach to a component of vehicle 20, such as a support structure, utilizing fasteners that also secure other components to the support structure. For example, bracket 78 can be attached to vehicle 20 utilizing the same fasteners used to attach direction lever assembly 60 to vehicle 20.

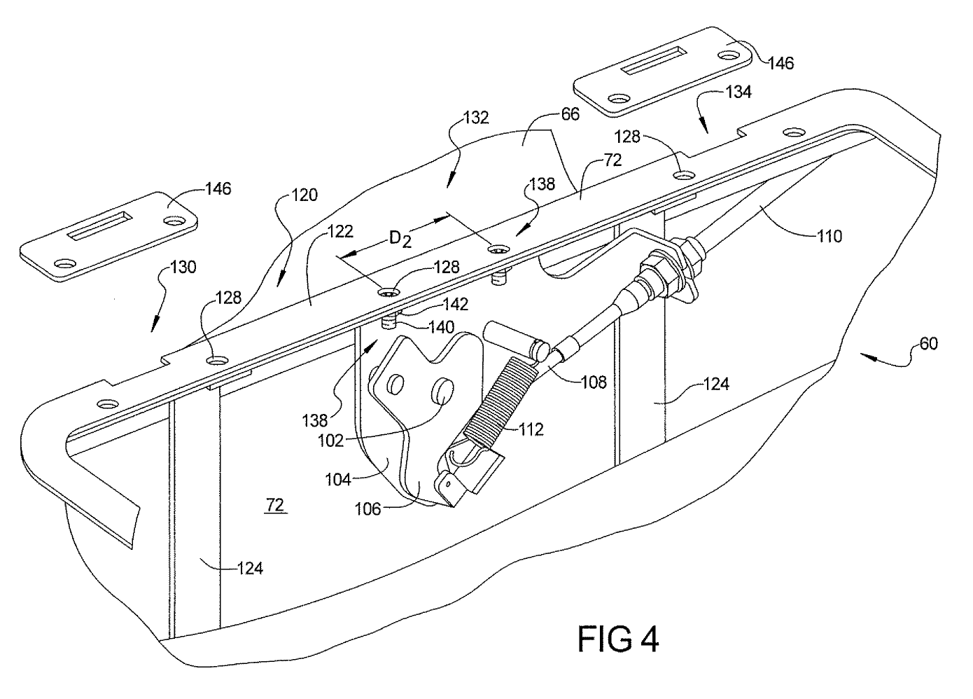

Referring to FIGS. 1 and 4, direction lever assembly 60 can include a lever 100 on the exterior of front seat panel 72 and having a shaft 102 that extends therethrough. Shaft 102 can extend through a bracket 104 that is inside of front seat panel 72 and be fixedly connected to a rotatable plate 106. A cable 108 can be secured to plate 106. A sheath 110 for cable 108 can be secured to bracket 104 to hold sheath 110 in a fixed position. A spring 112 can bias rotatable plate 106 to a desired orientation. Lever 100 can be rotated between two positions that correspond to the power unit propelling vehicle 20 in a forward and backward direction. Rotation of lever 100 translates into movement of cable 108 within sheath 110. The opposite end of cable 108 can be coupled to an appropriate component of the drive unit to cause the drive unit to propel vehicle 20 in either the forward or backward direction depending upon the position of lever 100.

Bracket 104 is secured to a seat support structure 120. Seat support structure 120 includes a horizontally-extending cross member 122 coupled to vertically-extending structural members 124. Structural members 124 can be coupled to frame 22 thereby providing a rigid seat support structure 120 to support bench seat 40 thereon. Cross member 122 can have a plurality of openings 128 extending therethrough that allow the attachment of components of vehicle 20 thereto. In the embodiments shown in FIG. 4, cross member 122 has three pairs of openings 130, 132, 134 that can receive fasteners, such as fasteners 138 shown disposed within second pair of openings 132. Fasteners 138 can include a threaded bolt 140 and a complementary threaded nut 142, as shown. Openings 128 can be used to attach a variety of components to vehicle 20. For example, openings 128 can be used to attach an upper lip of front seat panel 72 to cross member 122 thereby securing front seat panel 72 to vehicle 20. Additionally, openings 128 can also be used to secure other components, such as drive lever assembly 60 to seat support structure 120. Bracket 104 can include a flange portion with openings therein that align with second pair of openings 132. Fasteners 138 can be inserted through the openings in front seat panel 72, the openings in cross member 122 and the openings in bracket 104 and all three components secured together by securing nut 142 to bolt 140. The same type of fasteners 138 can be used in the first and third pair of openings 130, 134 to secure front seat hinge plates 146 and panel 72 to seat support structure 120 and/or to secure additional components to seat support structure 120. Fasteners 138 can be M10 and M6 fasteners.

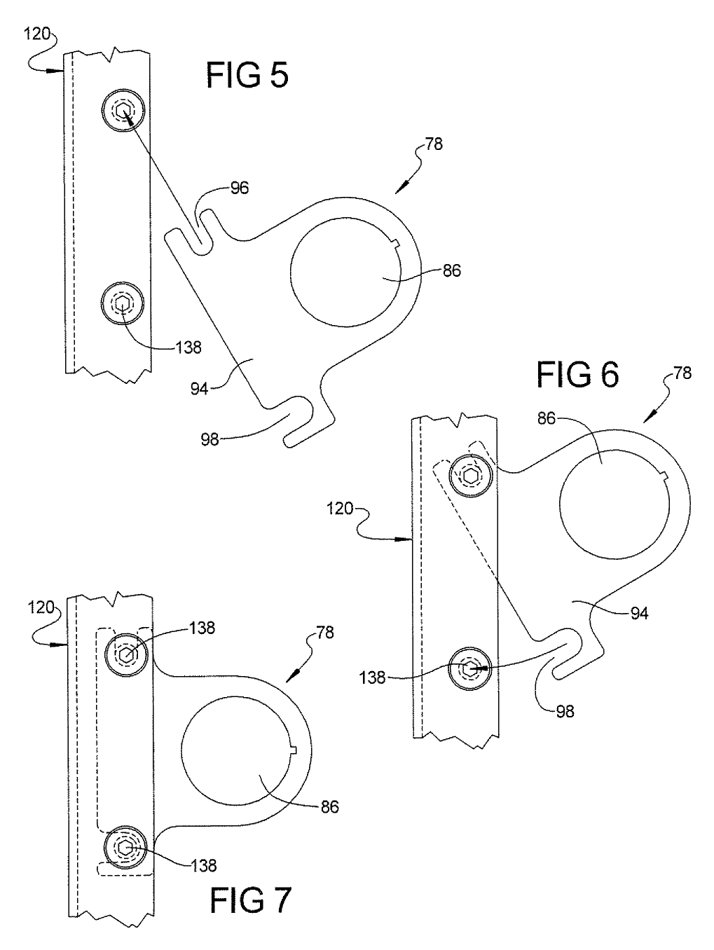

Bracket 78 according to the present disclosure can be attached to vehicle 20 using pair of openings 132 which has a distance D₂ between the centers of the pair of openings that is about the same as distance D₁ between the centers of channels 96, 98. The open ended configuration of channels 96, 98 allows bracket 78 to be attached using the same fasteners 138 that secure other components to seat support structure 120 without requiring the complete disengagement between bolt 140 and nut 142. That is, as shown in FIGS. 5-7, bracket 78 can be secured to seat support structure 120 merely by loosening nut 142 on bolt 140 an amount that enables the thickness of sidewall 84 of bracket 78 to fit between any two of the components being fastened together and/or the bolt head or nut. With fastener 138 sufficiently loosened, first channel 96 and mounting portion 94 can be inserted around the shaft of bolt 140 between the bottom surface of cross member 122 and the top side of bracket 104, as shown in FIGS. 5 and 6. With first channel 96 engaged with and extending around bolt 140, bracket 78 can be rotated, as shown in FIGS. 6 and 7, to cause second channel 98 to engage with the shaft of bolt 140 in the other opening of pair 132. Second channel 98 and mounting portion 94 can be disposed between the underside of cross member 122 and the top side of bracket 104 on the associated bolt 140. With both channels 96, 98 of bracket 78 engaged with the fasteners 138 in each opening of second pair of openings 132, as shown in FIG. 7, the nuts 142 can be rotated relative to bolt 140 to secure bracket 78 along with front seat panel 72 and bracket 104 to seat support structure 120.

It should be appreciated that mounting portion 94 and channels 96, 98 can be sandwiched between other components that are being assembled together using second pair of openings 132. For example, mounting portion 94 and channels 96, 98 can be disposed between the head of bolt 140 and the top surface of the top lip of front seat panel 72, between the bottom surface of the top lip of front seat panel 72 and the top surface of cross member 122, and between the bottom of the flange portion of bracket 104 and nut 142. Bracket 78 can be disposed in any of these positions without the necessity of removing nut 142 from bolt 140. Thus, mounting portion 94 and channels 96, 98 can be sandwiched between any two of the components that are assembled together or perform the assembling function at any of the pair of openings. Additionally, it should be appreciated that bracket 78 can be attached to a structural member with another pair of openings having fasteners therein regardless of the number of components being assembled to the support structure at that location providing the fasteners can accommodate the thickness of bracket 78.

With bracket 78 secured to seat support structure 120, meter 88 can be inserted into opening 86 of bracket 78 and secured thereto. Meter 88 can then be connected to the appropriate component within vehicle 20 to perform its intended function or operation. If desired, meter 88 can be secured to bracket 78 prior to bracket 78 being secured to seat support structure 120.

To remove bracket 78 from vehicle 20, fasteners 138 holding bracket 78 to seat support structure 120 can be loosened. The loosening of fasteners 130 can include rotating nut 142 relative to bolt 140. Nut 142 can remain attached to bolt 140. With the fasteners 138 loosened, bracket 78 can be rotated from the orientation shown in FIG. 7 to the orientation shown in FIG. 6 thereby disengaging second channel 98 from the associated fastener 138. Bracket 78 can then be pulled away from seat support structure 120, such as to the position shown in FIG. 5, to disengage first channel 96 from its associated fastener 138. Bracket 78 is then free of attachment to seat support structure 120 and a desired operation to bracket 78 can be undertaken.

While bracket 78 is shown as being attached to vehicle 20 using the same fasteners that secure direction lever assembly 60 to vehicle 20, it should be appreciated that bracket 78 can be attached to vehicle 20 using other fasteners that hold other components to vehicle 20. To facilitate the attachment of bracket 78 to various locations on vehicle 20, the various groups of openings within the various support structures of vehicle 20 can have a distance between the center of the openings that is approximately the same as the distance D₁ between the center of channels 96, 98. The use of these common dimensions enables bracket 78 to be secured to vehicle 20 using any set of two openings having these similar dimensions.

Thus, a bracket according to the present disclosure can be easily attached to a vehicle 20 utilizing existing fasteners. The bracket 78 can be attached to the vehicle 20 by merely loosening the fasteners and does not require the removal of the fasteners or the complete disengagement of the fasteners from their engaging component. Additionally, the bracket 78 can be easily removed from its mounting location to facilitate replacement, repair and/or to gain access to other components of vehicle 20 that bracket 78 would otherwise impair or inhibit. Additionally, bracket 78 can be disposed in any of a variety of locations thereby facilitating the attachment of bracket 78 in a desirable location.

The description herein is merely exemplary in nature and, thus, variations that do not depart from the gist of that which is described are intended to be within the scope of the disclosure. Such variations are not to be regarded as a departure from the spirit and scope of the disclosure.

What is claimed is:

1. A meter mounting bracket comprising:
a single unitary body;
a first elongated slot in the body, the first slot having a first open end opening in a first direction;
a second elongated slot in the body, the second slot having a second open end opening in a second direction different than said first direction; and
a component retaining feature in the body.

2. The mounting bracket of claim 1, wherein the first direction is substantially orthogonal to the second direction.

3. The mounting bracket of claim 2, wherein at least one of the slots is U-shaped in plan view.

4. The mounting bracket of claim 3, wherein both of the slots are U-shaped in plan view.

5. The mounting bracket of claim 2, wherein the first and second slots are co-planar.

6. The mounting bracket of claim 1, wherein the component retaining feature includes a generally circular opening in the body.

7. The mounting bracket of claim 6, wherein the component retaining features includes an alignment feature.

8. A small utility vehicle including the bracket of claim 1.

9. A small utility vehicle comprising:
a frame;
at least one driven wheel coupled to the frame;
a drive unit coupled to the frame and to the at least one driven wheel;
a structural member coupled to the frame;
a pair of openings in the structural member;
a single unitary bracket attached to the structural member, the bracket having first slot with a first open end opening in a first direction, the first slot aligned with a first one of the pair of openings, a second slot having a second open end opening in a second direction different than the first direction, the second slot aligned with a second one of the pair of openings; and
a pair of fasteners disposed in the pair of openings and in the slots, the fasteners securing the bracket to the structural member.

10. The small utility vehicle of claim 9, further comprising a meter attached to the bracket.

11. The small utility vehicle of claim 10, wherein the bracket includes an opening and the meter is disposed in the opening in the bracket.

12. The small utility vehicle of claim 11, wherein the bracket opening includes an alignment feature that is complementary to an alignment feature on the meter.

13. The small utility vehicle of claim 9, wherein the structural member is a seat support member.

14. The small utility vehicle of claim 13, further comprising a direction lever assembly mounted to the seat support member with the pair of fasteners securing the bracket and the lever assembly to the seat support member.

15. The small utility vehicle of claim 9, wherein the first direction is orthogonal to the second direction.

16. The small utility vehicle of claim 15, wherein the pair of openings is co-planar and the slots in the bracket are co-planar.

17. The small utility vehicle of claim 9, wherein the fasteners secure the bracket and another component of the small utility vehicle to the structural member.

18. The small utility vehicle of claim 17, wherein the other component includes a body panel.

19. The small utility vehicle of claim 9, further comprising a body panel having a pair of openings aligned with the pair of openings in the structural member with the pair of fasteners extending therethrough and securing the body panel and the bracket to the structural member.

20. The small utility vehicle of claim 9 configured as a golf car.

21. A method of securing a meter bracket to a small utility vehicle, the method comprising:
aligning a first open end of a first slot of a bracket with a first fastener extending through a structural member of the small utility vehicle, the first open end opening in a first direction;
engaging the first slot with the first fastener;
engaging a second open ended slot of the bracket with a second fastener extending through the structural member, the second slot having a second open end opening in a second direction different than the first direction; and
securing the bracket to the structural member with the first and second fasteners.

22. The method of claim 21, further comprising loosening the first and second fasteners prior to engaging the first and second slots with the respective first and second fasteners and maintaining the first and second fasteners engaged with a fastener retaining component while engaging the first and second slots with the respective first and second fasteners.

23. The method of claim 22, further comprising attaching a meter to the secured bracket.

24. The method of claim 21, wherein engaging the second open ended slot with the second fastener includes rotating the bracket about the first fastener.

25. The method of claim 21, further comprising securing another component of the small utility vehicle to the structural member with the first and second fasteners.

26. The method of claim 21, further comprising securing another component of the small utility vehicle to the structural member with the first and second fasteners prior to securing the bracket to the structural member with the first and second fasteners.

27. The method of claim 21, wherein the first direction is orthogonal to the second direction and the first and second slots are co-planar.
